(19) United States
(12) Patent Application Publication
(10) Pub. No.: US 2004/0238767 A1
(43) Pub. Date: Dec. 2, 2004

(54) Dye coated erase lamps in CR reader

(76) Inventors: David J. Steklenski, Rochester, NY (US); James H. Griggs, Rochester, NY (US)

Correspondence Address: Pamela R. Crocker, Eastman Kodak Company, Patent Legal Staff, 343 State Street, Rochester, NY, 14650-2201, US

(21) Appl. No.: 10/839,899

(22) Filed: May 6, 2004

Related U.S. Application Data
(60) Provisional application No. 60/468,375, filed on May 6, 2003.

(51) Int. Cl. G03B 42/08

(52) U.S. Cl. 250/588

(57) ABSTRACT

An apparatus and method for removing stored energy from a storage phosphor screen in which a radiation image was recorded and then read by collecting stimulated emission from the phosphor sheet. The method is accomplished by directing onto the storage phosphor sheet an erasing light having substantially no light of a wavelength of shorter than 410 nm. The apparatus of an erasing light is provided by coating a light source with a yellow dye.

### CROSS REFERENCE TO RELATED APPLICATIONS

This is a 111A application of Provisional Application Ser. No. 60/468,375, filed May 6, 2003, incorporated herein by reference.

### FIELD OF THE INVENTION

The invention is directed to a storage phosphor imaging system, and more particularly, to the erasure of storage phosphor.

### BACKGROUND OF THE INVENTION

Storage phosphor imaging systems are known. In one such system, a storage phosphor is exposed to an x-ray image of an object, such as a body part of a patient, to record a latent x-ray image in the storage phosphor. The latent x-ray image is read out by stimulating the storage phosphor with stimulating radiation. Upon stimulation, the storage phosphor releases emitted radiation of a particular wavelength. To produce a signal useful in electronic image processing, the storage phosphor is scanned, for example, by a laser beam deflected by an oscillating or rotating scanning mirror or by a rotating polygon. The emitted radiation from the storage phosphor is reflected by a collector and detected by a photodetector, such as a photomultiplier, to produce an electronic x-ray image signal. The x-ray image signal can then be viewed as a visual image produced by a softcopy display device, such as a CRT or LCD display, or a hardcopy display device, such as a x-ray film printer (laser printer, CRT printer, thermal printer).

U.S. Pat. No. Re. 31,847 (Luckey) discloses a storage phosphor system. The reader is often referred to as a computed radiography (CR) reader.

The storage phosphor can be disposed on a medium, such as a sheet or a screen. After the storage phosphor is processed/scanned/read/exposed by the storage phosphor processor/reader, the storage phosphor can be fed to an erasing unit to erase the radiation image information from the storage phosphor, after which the storage phosphor is returned to the cassette for reuse.

Erasure of the storage phosphor is known, such as disclosed in U.S. Pat. Nos. 5,237,177 (Kimura); 5,534,709 (Yoshimoto); 5,550,386 (Kojima); 6,140,663 (Neary); 6,339,225 (Funabashi); and 5,534,710 (Suzuki).

Accordingly, there exists a need for an apparatus to erase the latent image from the medium after the latent image has been scanned/processed/read/exposed.

### SUMMARY OF THE INVENTION

According to one aspect of the present invention, there is provided a CR reader having means to erase the storage phosphor disposed on a medium.

According to another aspect of the present invention, there is provided an apparatus to effect erasure of the storage phosphor disposed on a medium.

This object is given only by way of illustrative example, and such object may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided a method for erasing a radiation image remaining in a storage phosphor sheet in which a radiation image was recorded and then read by collecting stimulated emission from the storage phosphor sheet. The method is accomplished by directing onto the storage phosphor sheet an erasing light having substantially no light of a wavelength of shorter than 410 nanometers. The erasing light is provided by coating a light source with a yellow dye.

### BRIEF DESCRIPTION OF THE DRAWINGS

The foregoing and other objects, features, and advantages of the invention will be apparent from the following more particular description of the preferred embodiments of the invention, as illustrated in the accompanying drawings.

FIG. 1 shows a front perspective view of a storage phosphor reader in accordance with the present invention.

FIG. 2 shows a left side plan view of the storage phosphor reader of FIG. 1.

FIG. 3 shows the erase assembly of the storage phosphor reader of FIG. 2.

FIG. 4 shows an exemplary screen.

FIG. 5 shows an exemplary emission spectrum of a typical fluorescent lamp.

FIG. 6 shows a light transmission spectrum of two example lamp coatings in accordance with the present invention.

### DETAILED DESCRIPTION OF THE INVENTION

The following is a detailed description of the preferred embodiments of the invention, reference being made to the drawings in which the same reference numerals identify the same elements of structure in each of the several figures.

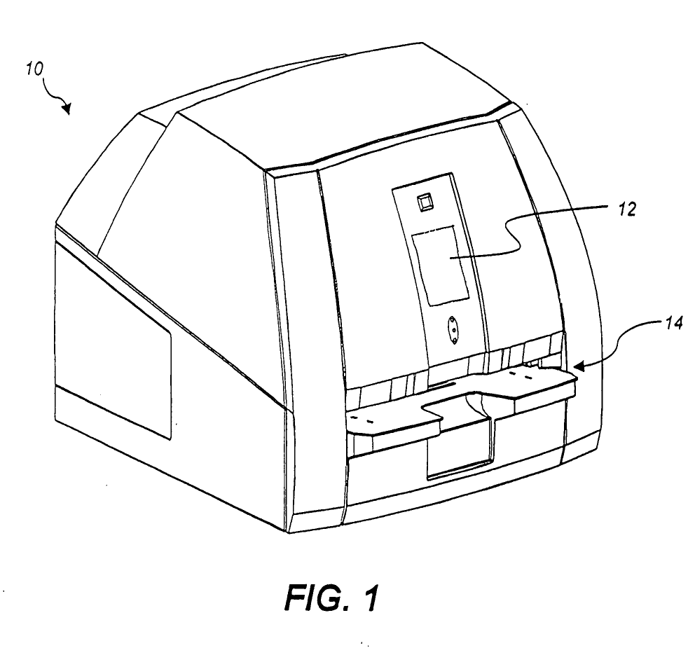

Referring to FIGS. 1 through 3, there is shown an exemplary storage phosphor reader 10 in accordance with the present invention. Storage phosphor reader 10 processes images captured on storage phosphor using conventional radiographic equipments. Reader 10 then scans the storage phosphor and converts the latent x-ray image therein into an electrical x-ray image signal which can be viewed. Reader 10 can optionally include a touch screen, generally illustrated in FIG. 1 as display 12, for initiating operations of reader 10 or displaying information.

The storage phosphor used to hold the latent image can be erased and used repeatably. The storage phosphor can be disposed on a flexible or semi-flexible medium, such as a sheet, which can be mounted in an x-ray cassette. An example of such a cassette is disclosed in U.S. Ser. No. 10/767,277 (Kodak Docket No. 85921) provisionally filed on Feb. 3, 2003 as Provisional Application U.S. Ser. No. 60/444,462, commonly assigned and incorporated herein by reference. Such cassettes can be of varying sizes. The medium is often referred to as a sheet or screen.

Once the radiology technologist exposes a body part to an x-ray which is storage as a latent image on the screen, the cassette is loaded into reader 10 at a receiving station or supply area 14. Cassette supply area 14 is shown in FIG. 1 as a load platform. Scanning can be initiated by various methods, for example, by loading the cassette in supply area 14 or by pressing a start button on display 12.

Inside reader 10, using means known to those skilled in the art, the screen is extracted from the cassette and moved along a path P in a direction A through a scan area 16 wherein the screen is scanned. Once a portion of the screen has been scanned, it is erased by being moved through an erase area 18 wherein it is erased by exposure to light which removes the remnants of the image, as will be more particularly described below.

Once the entire screen has been scanned and erased, the direction of the screen is reversed and the screen is returned to the cassette.

It is recognized that the screen can be erased in the return direction (i.e., when being returned to the cassette) rather than the forward direction (i.e., direction A).

A light cover 20 can be provided to shield the scan area from exposure to ambient or room light. Light cover 20 can also be employed to shield other elements of reader 10, such as the scan element and collector from exposure to ambient or room light.

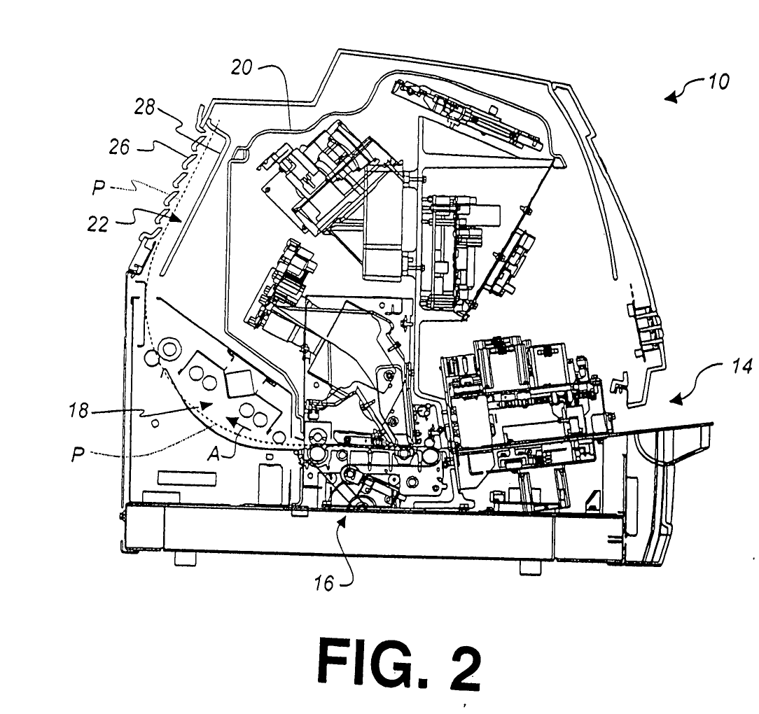

As best shown in FIG. 2, portions of the screen may extend beyond erase area 18, particularly if the screen is of a larger size. Accordingly, a portion of the screen may be disposed within an area herein referred to as an access area 22. Access area 22 is an area disposed proximate path P outside of erase area 18 and which is not shielded by light cover 20. If desired, a cover or other access member 26 can be configured to shield/cover access area 22. Cover 26 is configured to be removable from reader 10 so that the portion of the screen disposed within access area 22 can be accessed. An optional support member 28 can be provided to provide some support for the screen when disposed within access area 22.

While the present invention is described with regard to a flexible or semi-flexible storage phosphor medium, it is recognized that storage phosphor can be disposed on a rigid or semi-rigid plate and mounted in an x-ray cassette. U.S. Pat. No. 5,943,390, commonly assigned and incorporated herein by reference, discloses such a cassette. Such plates and cassettes can be of varying sizes. A reader in accordance with the present invention can be configured to accept such a rigid or semi-rigid plate. For example, path P is substantially linear/planar and erase area 18 may be disposed along path P.

Reader 10 can include a reverse path feed option to allow reader 10 to be used as an erase-only device, for example, when not used as a reader.

As indicated above, once a portion of the screen has been scanned, it is erased by being moved through an erase area 18 wherein it is erased by exposure to light which removes the remnants of the image. It is desirable to erase substantially all the latent image from the screen prior to returning the screen to the cassette.

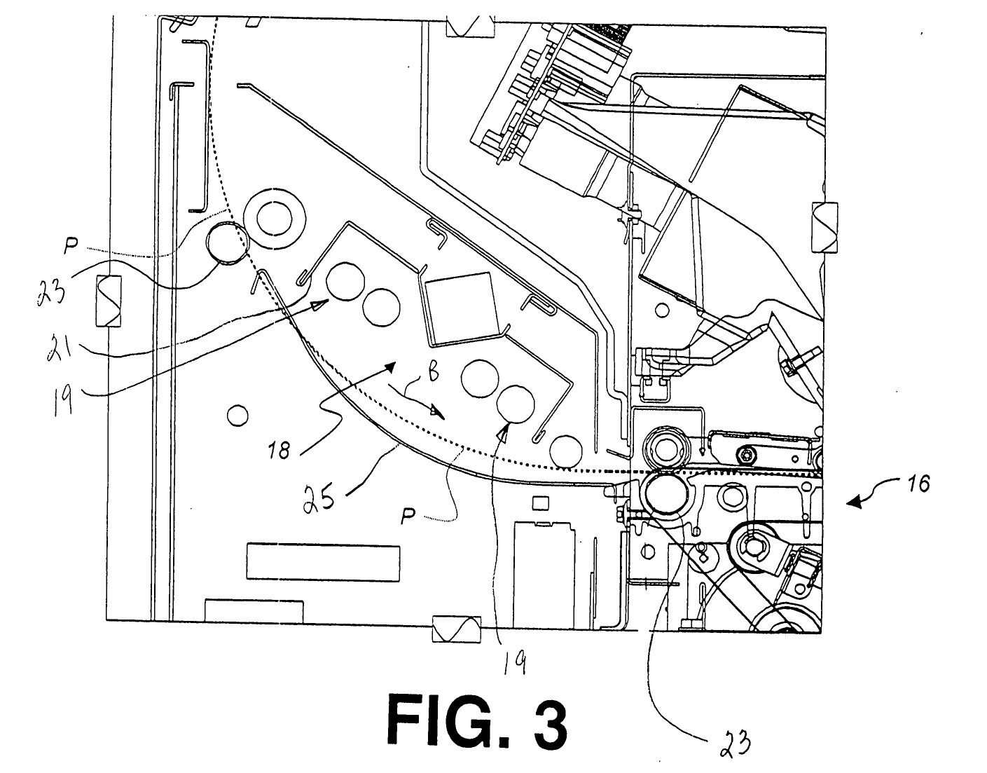

The light exposure can be from a fluorescent lamp, mercury lamp, metal halide lamps, and the like. As best shown in FIGS. 2 and 3, erase area 18 includes at least one light source member 19. Light source members are well known and can include known light sources such as a fluorescent lamp, sodium lamps, metal halide lamps, mercury lamps, and the like. As shown, a plurality of light source members are shown. In a preferred embodiment, light source member 19 is configured in a U-shape, so is shown in the cross-sectional view of FIGS. 2 and 3 as two circles. In a preferred embodiment, light source member 19 is ON when the screen is in erase area 18.

A reflector 21 can be provided proximate light source member 19 to direct light emitted by member 19 toward path P.

Rollers can be employed to transport the screen into and out of erase area 18. FIGS. 2 and 3 show a plurality of roller pairs 23 providing transport of the screen along path P.

An optional guide member 25 disposed proximate path P in erase area 18 can be employed to promote transport of the screen through erase area 18.

In the embodiments shown in FIGS. 2-3, only a portion of the screen can be disposed within erase area 18 since erase area 18 is smaller in size than the screen. That is, erase area 18 cannot hold the entire screen. Consequently, only a portion of the screen can be erased at a particular period of time. Therefore, the screen is moved through erase area 18 in a manner so as to access all portions of the screen for erasure.

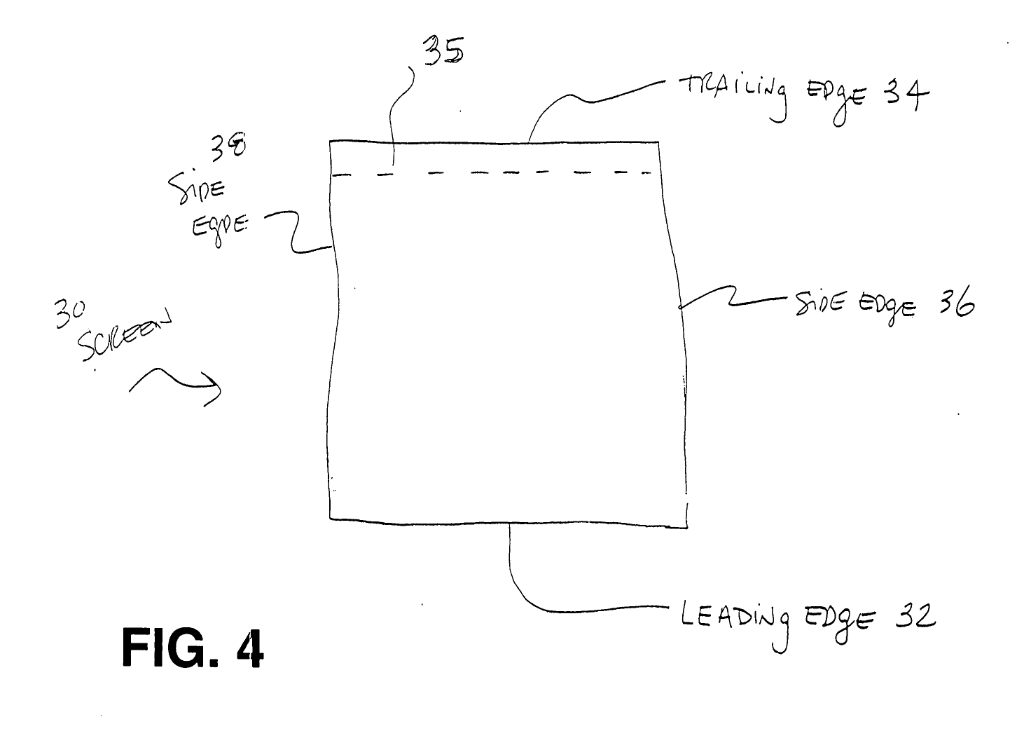

FIG. 4 generally illustrates an exemplary screen 30. A leading edge 32 of screen 30 first enters scan area 16 and subsequently, erase area 18. A trailing edge 34 of screen 30 is opposite leading edge 32. An area of screen 30 disposed along the length of screen 30 adjacent trailing edge 34 is shown generally in FIG. 4 as trailing portion 35. This area of screen 30 is the last portion of the screen to enter erase area 18. Since the screen is transported through erase area 18 at the same speed as through scan area 16, Applicants have recognized that trailing edge 34 and trailing portion 35 may not be effectively erased if the screen direction is reversed immediately upon completion of the scanning. One method to promote effective erasure of trailing portion 35 is to stop (i.e., dwell) transport of the screen for a predetermined time in erase area 18 before the direction of the screen is reversed (i.e., arrow B) to return the screen to the cassette.

It has been suggested that the storage phosphor of the screen can be progressively desensitized by exposure to erase light. This desensitization might not be recognized in CR readers wherein the entire screen is simultaneously and/or uniformly erased. However, in CR readers wherein the entire screen is not simultaneously/uniformly erased, it has been suggested that the desensitization can promote non-uniformities in the image.

Accordingly, to reduce any desensitization that might occur as a result of erasure, the present invention is directed to employing a coating on light source member 19 to block/filter the shorter wavelengths which might cause the desensitization yet pass the longer wavelengths which accomplish the erasure.

The dyes are dissolved in a solvent along with a suitable binder, for example, suspended in a but-var binder. This coating solution may be coated directly on the glass of the lamp, or a primer can be used to improve the overall adhesion and wetability of the coating solution.

Several dyes and dye combinations are suitable for the practice of the present invention. Requirement for the dye include an absorption spectrum that allows the removal of the unwanted wavelengths, and a solubility in the solvents used to dissolve the polymeric binder.

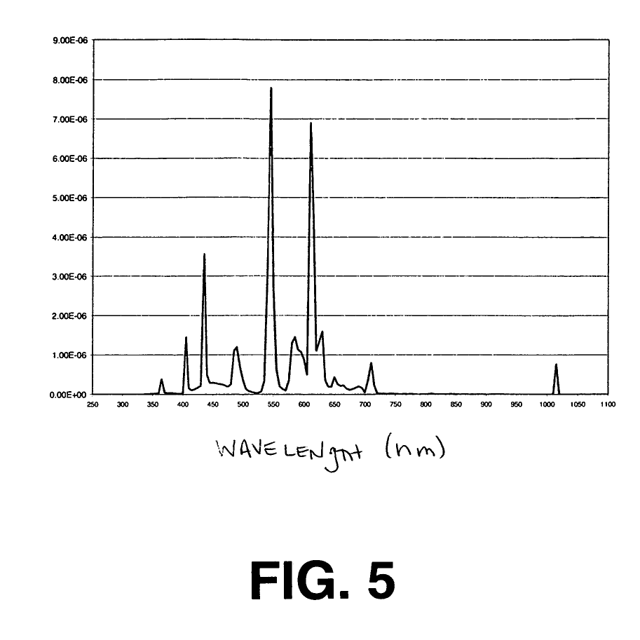

An emission spectrum of a typical fluorescent lamp, as could be used to erase the residual image on a storage phosphor screen, is shown in FIG. 5. It is desirable to remove the lamp emissions at 380 nm and 405 nm. At the same time, it is desirable not to affect the emissions at wavelengths greater than 500 nm as these wavelengths are effective in the erasure of the screen.

Yellow dyes and pale yellow dyes which absorb in the shallow UV (ultra violet) can be employed. It is desirable that the extinction coefficient of the dye be as high as possible so that relatively small amounts of the dye will effectively remove the undesired emissions without requiring the application of large amounts of dye to the lamp.

In some instances, a single dye may possess sufficient or substantially all of the properties required, yet it may be advantageous to use a combination of two or more dyes to insure that as much of the undesirable radiation as possible is absorbed.

The dye or combinations of dyes should also possess a high level of light and thermal stability. Fading of the dye or loss in the dye due to the heat of the lamps could cause a change in the output spectrum that could, overtime, induce problems these coatings are intended to address.

The polymeric binder can be any of a plurality of typical, solvent soluble, polymeric materials. Requirements for the polymeric binder are solubility in a suitable coating solvent, the ability to adhere to the glass of the lamp, and a suitable degree of light and thermal stability. Examples of binders useful for the coatings of the present invention include, but are not limited to, cellulosic binders, and particularly cellulose acetate, acrylate and methacrylate polymers, for example methylmethacrylate, polyvinyl acetate, polyvinyl butyral, polyurethanes and other typical coating binders.

The coatings can be applied from typical coating solvents. Most desirable solvents include low boiling ketones, such as acetone and methyl ethyl ketone, alcohols such as methanol and ethanol and chlorinated solvents such as methylene chloride. Acetone is particularly preferred due to its fast evaporation and low toxicity.

Additives can be added to the coating formulation to promote adhesion or improve wetting. Examples of such additives are surfactants and antifoamants used to improve the appearance and uniformity of the coating.

The coating can be applied to the lamp using any number of common application methods. A preferred coating method is dip coating wherein the lamps are immersed in the coating solution and withdrawn at a slow, controlled rate. The coating can also be applied as a spray or by brush or roller applicator.

### EXAMPLE 1

A lamp coating solution was prepared by adding 204 g of cellulose acetate (CA398-3, Eastman Chemical Corp.) to 1700 g of acetone. This mixture was stirred until the cellulose acetate was fully dissolved.

To the polymer solution was added 18.5 g of (3-(dihexylamino)-2-propenylidene)propanedinitrile (Eastman Kodak Co.). When the dye was fully dissolved, the solution was poured into a 2 1 graduated cylinder. A pair of fluorescent lamps was coated by immersing the glass portion of the lamps into the coating solution and then withdrawing the lamps at a rate of 12 inches per minute. The coating was air dried for 15 minutes and then cured in an oven for 30 minutes and 50 degrees centigrade.

### EXAMPLE 2

A lamp coating solution was prepared by adding 204 g of cellulose acetate (CA398-3, Eastman Chemical Corp.) to 1700 g of acetone. This mixture was stirred until the cellulose acetate was fully dissolved. To the polymer solution was added 18.5 g of (3-(dihexylamino)-2-propenylidene)propanedinitrile (Eastman Kodak Co.) and 10 g of Mackrolex Yellow 6 G (Bayer Corp). When the dyes were fully dissolved, the solution was poured into a 2 1 graduated cylinder. A pair of fluorescent lamps was coated by immersing the glass portion of the lamps into the coating solution and then withdrawing the lamps at a rate of 12 inches per minute. The coating was air dried for 15 minutes and then cured in an oven for 30 minutes and 50 degrees centigrade.

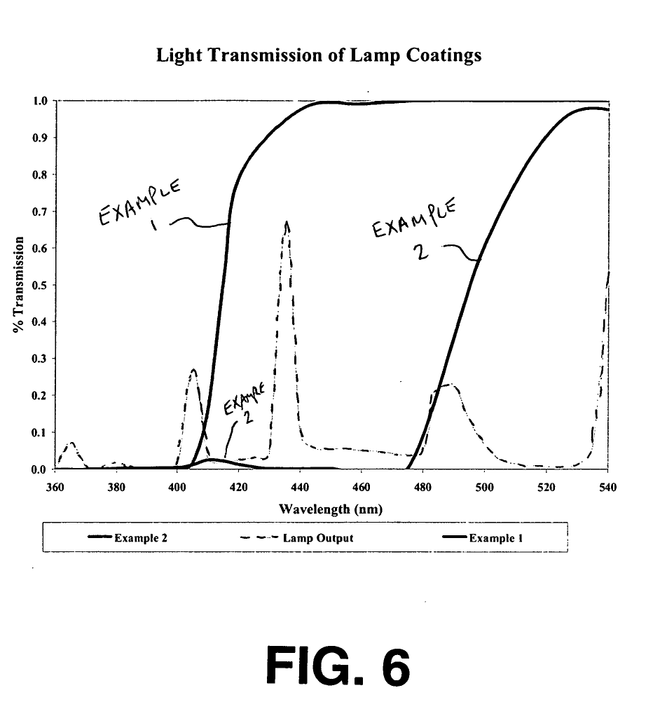

The transmission spectrum of the coatings of Example 1 and Example 2 described above is shown in FIG. 6. As shown in the figure, coatings have significant absorption to remove the undesired lamp emissions below about 410 nm.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

### Parts List

10 storage phosphor reader

12 touch screen display

14 cassette supply area

16 scan area

18 erase area

19 light source member

20 light cover

21 reflector

22 access area

23 rollers

26 cover

28 optional support member

What is claimed is:

1. A method for erasing a radiation image remaining in a storage phosphor sheet in which a radiation image was recorded and then read by collecting stimulated emission from the storage phosphor sheet, comprising the step of:
directing onto the storage phosphor sheet an erasing light having substantially no light of a wavelength of shorter than 410 nanometers.

2. A method for erasing a radiation image remaining in a storage phosphor sheet in which a radiation image was recorded and then read by collecting stimulated emission from the storage phosphor sheet, comprising the steps of:
providing an erasing light having substantially no light of a wavelength of shorter than 410 nanometers, the erasing light being a light source coated with a yellow dye; and
directing the erasing light onto the storage phosphor sheet to effect erasure.

3. An apparatus for removing stored energy from a storage phosphor sheet in which a radiation image was recorded and then read by collecting stimulated emission from the phosphor sheet, comprising:
at least one erasing light source, the light source comprising a coating whereby the light source emits a light having substantially no light of a wavelength of shorter than 410 nanometers.

4. The apparatus of claim 3, further comprising:
an erase area including the at least one erasing light source; and
control means for effecting transport of the phosphor sheet along a path in a first direction into the erase area to expose the phosphor sheet disposed within the erase area to the at least one light source to affect erasure of the radiation image on the phosphor sheet.

5. The apparatus of claim 3, wherein the coating comprises a yellow dye.

6. The apparatus of claim 5, wherein the yellow dye is formed by dissolving the dye in a solvent and polymeric binder.

7. The apparatus of claim 6, wherein the yellow dye further comprises an additive to promote adhesion of the coating to the light source.

8. The apparatus of claim 3, wherein the coating is applied to the light source by immersing the light source in a coating solution comprising a yellow dye.
